(19) United States
(12) Patent Application Publication
(10) Pub. No.: US 2010/0251213 A1
(43) Pub. Date: Sep. 30, 2010

(54) METHOD FOR EXECUTING DEBUG COMMANDS

(75) Inventor: Yinon Yamin, Rehovot (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: HORIZON SEMICONDUCTORS LTD., Herzliya (IL)

(21) Appl. No.: 12/409,653

(22) Filed: Mar. 24, 2009

(51) Int. Cl. G06F 11/36

(52) U.S. Cl. 717/124

(57) ABSTRACT

The present invention relates to a method for cycle accurate simulating the processing of a processor comprising the steps of: (a) receiving a source code containing at least one source command and at least one debug command; (b) reading at least one command from said source code and determining if said command is a source command or a debug command; (c) if said command is a source command: (I) interpreting said source command into machine readable command; and (II) storing said source command in an object code file; (d) if said command is a debug command: (I) appending an address to said debug command; and (II) storing said debug command in a debug file; (e) loading said object code file and said debug file into a cycle accurate simulator; and (f) executing at least one said debug command without promoting at least one component which keeps track of the processing cycle accuracy of said simulated processor.

### FIELD OF THE INVENTION

The present invention relates to the field of simulators. More particularly, the invention relates to a method for processing debug commands during the simulation of processing an object code.

### BACKGROUND OF THE INVENTION

A microprocessor architecture simulator, or an architectural simulator, is a piece of software to model processing chips (or components) for predicting outputs and performance metrics on a given input.

An instruction set simulator is a simulator that mimics the behavior of a microprocessor by reading and processing the commands of an object code and accordingly maintaining internal variables which represent the processor's registers.

A Cycle Accurate Simulator is a simulator that simulates a micro-architecture cycle-accurately. In other words, the simulator simulates the factual processing capabilities of the source code by the microprocessor, as accurately as possible, taking into account the hardware limitations, of the microprocessor, for each cycle.

The basic instruction simulation technique is the same regardless of purpose-first execute the monitoring program passing the name of the target program as an additional input parameter. The target program is then loaded into memory, but control is never passed to the code. Instead, the entry point within the loaded program is calculated and a pseudo program status word is set to this location. A set of pseudo registers are set, to what they would have contained, if the program had been given control directly.

One of the main advantages for employing simulation, aside from monitoring and executing the machine code instructions, is for test and debugging purposes, e.g. with memory protection.

The importance of a good debugger cannot be overstated. Indeed, the existence and quality of such a tool for a given language and platform can often be the deciding factor in its use, even if another language/platform is better-suited to the task. However, it is also important to note that software can (and often does) behave differently running under a debugger than normally, due to the inevitable changes the presence of a debugger will make to a software program's internal timing. As a result, even with a good debugging tool, it is often very difficult to track down runtime problems in complex multi-threaded or distributed systems.

U.S. Pat. No. 5,815,714 discloses a method and apparatus for re-generating debug commands. The disclosed assembler operates on the source code extracting the embedded debug commands and associated address information from the source code while generating an object code. The debug commands are stored in a command file for use during simulation. A simulator executes the assembled object code in conjunction with a debugger which executes the stored debug commands as designated during the execution cycle. Upon the termination of a simulation run and the subsequent modification of the source program, the debug commands are automatically re-generated with correct addresses as determined during the subsequent assembly. When the edited source file is loaded, the break-points are cleared and a new command file is executed to insure that the break-points are relocated to the correct source lines. The execution of the embedded debug commands can be enabled or disabled by means of a command line option, so when the debugging is complete, the debug information will not be outputted. Nevertheless, the described method deals with debug commands which are preset and indicated by the user.

It is an object of the present invention to provide a method for processing debug commands during the simulation of processing an object code.

Other objects and advantages of the invention will become apparent as the description proceeds.

### SUMMARY OF THE INVENTION

The present invention relates to a method for cycle accurate simulating the processing of a processor comprising the steps of: (a) receiving a source code containing at least one source command and at least one debug command; (b) reading at least one command from said source code and determining if said command is a source command or a debug command; (c) if said command is a source command: (I) interpreting said source command into machine readable command; and (II) storing said source command in an object code file; (d) if said command is a debug command: (I) appending an address to said debug command; and (II) storing said debug command in a debug file; (e) loading said object code file and said debug file into a cycle accurate simulator; and (f) executing at least one said debug command without promoting at least one component which keeps track of the processing cycle accuracy of said simulated processor.

Preferably, the source code is first compiled from a source program by a complier.

Preferably, the compiler is programmed to compile debug commands from a source program into specifically set debug source code commands.

Preferably, the debug commands are stored in a textual format.

In one embodiment, the debug commands are stored in a binary format.

The present invention also relates to a method for cycle accurate simulating the processing of a processor comprising the steps of: (a) receiving a source code containing at least one source command and at least one debug command; (b) reading at least one command from said source code and determining if said command is a source command or a debug command; (c) if said command is a source command: (I) interpreting said source command into machine readable command; and (II) storing said source command in the source command section of an object code file; (d) if said command is a debug command: (I) appending an address to said debug command; and (II) storing said debug command in the debug section of the object code file; (e) loading said object code file into a cycle accurate simulator; and (f) executing at least one said debug command without promoting at least one component which keeps track of the processing cycle accuracy of said simulated processor.

### BRIEF DESCRIPTION OF THE DRAWINGS

In the drawings:

FIG. 1 is a process flow chart of a prior art simulator.

FIG. 2 is a flow chart of the method of the invention according to an embodiment.

FIG. 3 depicts an example of a source code and its corresponding files.

FIG. 4 is a flow chart of the method of the invention according to another embodiment.

### DETAILED DESCRIPTION OF PREFERRED EMBODIMENTS

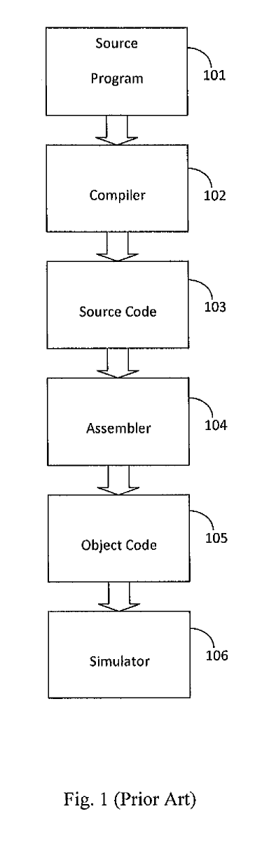

FIG. 1 is a process flow chart of a prior art simulator. At first, a user compiles his source program 101, typically written in a high level programming language, using a compiler 102. The source program 101 typically contains break-point debug commands which set break-points at locations in the source file, indicated by an address, a label or as an offset from a label. Typically a programmer will create these break-point commands manually during the simulation set up, providing for a breakpoint prior to the execution of a particular instruction. The compiler 102 translates the source program 101 into an assembly source code 103. The assembly source code 103, containing source and debug commands, is then parsed and interpreted by assembler 104 into machine readable object code 105. The object code 105, containing source and debug commands, is then loaded into simulator 106 which simulates a selected processor. During simulation, the simulator executes the source and debug commands, of object code 105, one by one until it arrives at a designated break-point. At break-points, debugger commands are utilized to examine registers, variables and other program parameters. If a parameter is inconsistent with expected results, then the user knows that there is a potential bug in the program. The debugger commands are then used to print out a message, continue or halt the program.

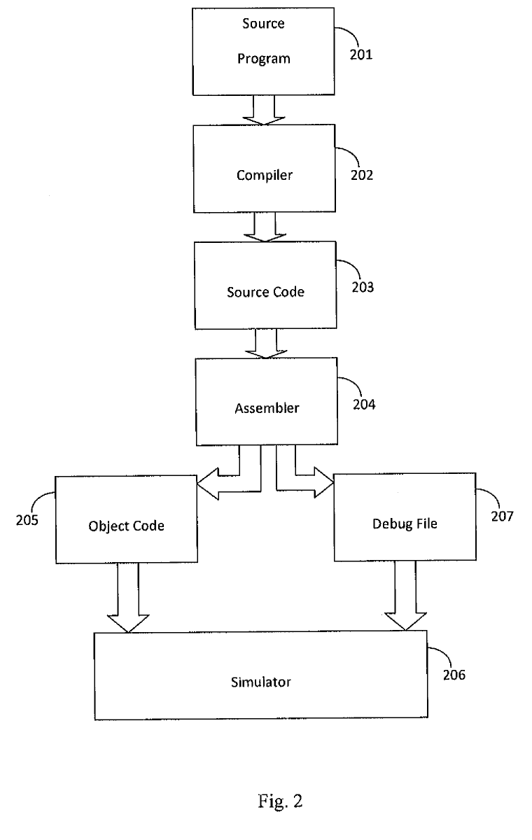

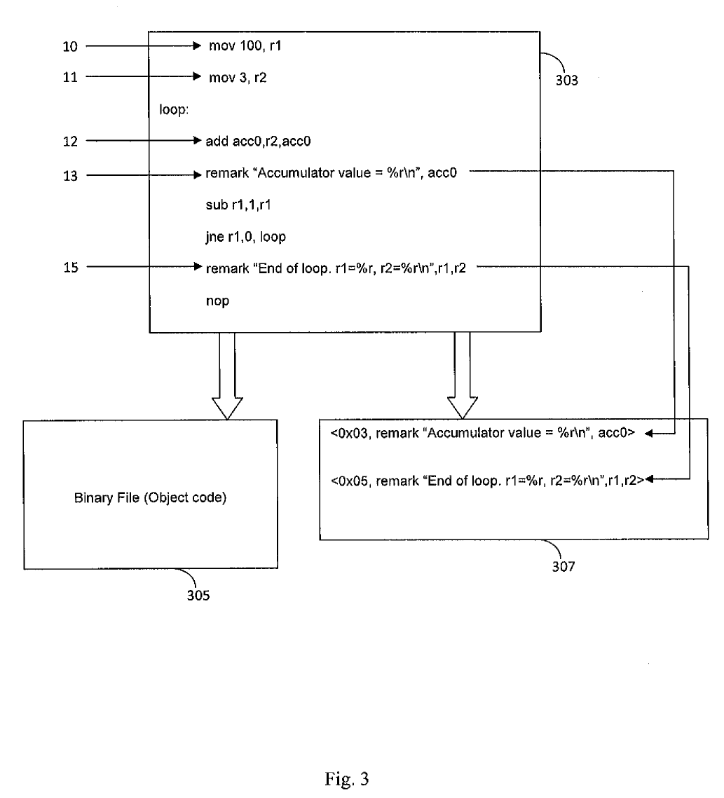

FIG. 2 is a flow chart of the method of the invention according to an embodiment. At first a user compiles his source program 201, if written in a high level programming language, using a compiler 202. The source program 201 typically contains source and debug commands. The compiler 202 compiles the source program 201 into an assembly source code 203, where, according to one embodiment, debug commands recognized by the compiler 202 are marked. The mark may be a designated mark unrelated to the assembly language of the source code 203, or the mark may be a known assembly command, or commands, which the debug commands of the source program 201 are compiled to. The assembly source code 203, which contains the source and debug commands, is then parsed and interpreted by assembler 204. Assembler 204 can differentiate between the source code commands and the debug commands, as will be described later in relations to FIG. 3. The assembler 204 reads each command and decides if the command is a code command or a debug command. If the read command is a code command, the assembler 204 interprets it into a binary machine readable command and stores it in the object code file 205. If the read command is a debug command, then assembler 204 appends a Program Counter (PC) address to the read command and stores it in the debug file 207. In one of the embodiments the debug command is also modified prior to storing the debug command in the debug file 207. In one of the embodiments the debug commands are stored in a textual format. The object code 205 and the debug file 207 are then loaded into Cycle Accurate Simulator 206 which simulates the processing of a preset processor. During simulation, the simulator 206 executes the commands of object code 205 one by one together with reading the PC addresses from debug file 207. Meaning that before executing a code command from the object code 205, simulator 206 reads the PC of the code command and then checks if the debug file 207 contains a debug command with a corresponding PC address. If a debug command having a corresponding PC address exists, then that debug command is executed without promoting the simulator components which keep track of the processing cycles of the simulated microprocessor, such as the simulated clock of the microprocessor. If there is no debug command having a corresponding PC address, the subsequent code command from object code 205 is executed, and the PC is promoted. Thus the source and debug commands are executed according to the user's written source program, without allowing the execution of the debug commands to influence the cycle accurate execution simulation of an object code.

FIG. 3 depicts an example of a source code and its corresponding files. The example of a source code 303 shows a number of source commands and two debug commands labeled 13 and 15. According to one embodiment, when the assembler reads and interprets the commands of source code 303, the code commands are converted to machine readable binary code and the debug commands are stored in a textual format. For example the first command 10 starting with “mov” is a code command and it will be interpreted into binary machine code and stored in the binary file 305 as the first object code command. The second command 11 starting with “mov” and the third command 12 starting with “add” are interpreted into machine binary code and stored in the binary file 305 as the second and third object code commands. However, the forth command 13 starting with “remark” is found by the assembler to be a debug command, hence, the command is stored in the debug file 307 together with the PC of the next code command—0x03 (as it will be the fourth command of the object code binary file 305). In one of the embodiments, the assembler has a list of the debug commands wording, where any command starting with the wording of the list is categorized as a debug command. Thus the assembler continues interpreting the source code commands until the end of the source code.

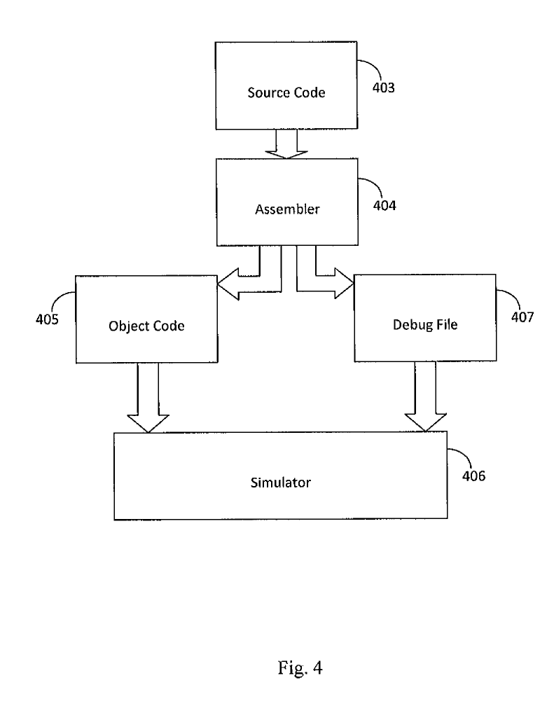

FIG. 4 is a flow chart of the method of the invention according to another embodiment. At first a user loads a source code 403, written in assembly, containing the source and debug commands into assembler 404. The assembly source code 403 is then parsed and interpreted by assembler 404. The assembler 404 reads each command and decides if the command is a code command or a debug command. If the read command is a code command, the assembler 404 interprets it into a binary machine readable command and stores it in the object code 405. If the read command is a debug command, then assembler 404 appends a Program Counter (PC) address to the read command and stores it in the debug file 407. In one of the embodiments, the appended PC address is the address of the next source command in the object code 405. In one of the embodiments the debug command is also modified prior to storing the debug command in the debug file 407. The object code 405 and the debug file 407 are then loaded into Cycle Accurate Simulator 406 which simulates the processing of a selected processor. During simulation, the simulator 406 executes the commands of object code 405 one by one together with reading PC addresses from debug file 407. Meaning that before executing an object code command, simulator 406 reads the PC of the code and then checks if the debug file 407 contains a debug command with a corresponding PC address. If a debug command having a corresponding PC address exists, that debug command is executed without promoting the components which keep track of the processing cycles of the simulated microprocessor. If there is no debug command having a corresponding PC address, the subsequent object code command from object code 405 is executed, and the PC is promoted. Thus the source and debug commands are executed according to the user written source program, without allowing the execution of the debug commands to influence the cycle accurate execution simulation of the object code.

In one embodiment, when the compiler compiles the source program into assembly, all the high level commands intended for debug purposes, such as “print” in C, are compiled to one of the preset debug assembly commands such as “remark”.

In one of the embodiments, the object code commands and the debug commands are stored in different sections of the same file, and that single file is loaded into the simulator.

In one of the embodiments, the debug commands are stored in binary format in the debug file. In another embodiment, the debug commands are stored in textual format in the debug file.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for cycle accurate simulating the processing of a processor comprising the steps of:
a. receiving a source code containing at least one source command and at least one debug command;
b. reading at least one command from said source code and determining if said command is a source command or a debug command;
c. if said command is a source command:
i. interpreting said source command into machine readable command; and
ii. storing said source command in an object code file;
d. if said command is a debug command:
i. appending an address to said debug command; and
ii. storing said debug command in a debug file;
e. loading said object code file and said debug file into a cycle accurate simulator; and
executing at least one said debug command without promoting at least one component which keeps track of the processing cycle accuracy of said simulated processor.

2. A method according to claim 1, where the source code is first compiled from a source program by a complier.

3. A method according to claim 2, where the compiler is programmed to compile debug commands from a source program into specifically set debug source code commands.

4. A method according to claim 1, where the debug commands are stored in a textual format.

5. A method according to claim 1, where the debug commands are stored in a binary format.

6. A method for cycle accurate simulating the processing of a processor comprising the steps of:
a. receiving a source code containing at least one source command and at least one debug command;
b. reading at least one command from said source code and determining if said command is a source command or a debug command;
c. if said command is a source command:
i. interpreting said source command into machine readable command; and
ii. storing said source command in the source command section of an object code file;
d. if said command is a debug command:
i. appending an address to said debug command; and
ii. storing said debug command in the debug section of the object code file;
e. loading said object code file into a cycle accurate simulator; and
f. executing at least one said debug command without promoting at least one component which keeps track of the processing cycle accuracy of said simulated processor.
